(19) United States
(12) Patent Application Publication
(10) Pub. No.: US 2009/0183617 A1
(43) Pub. Date: Jul. 23, 2009

(54) SHANK AND DIAMOND SCRIBER ASSEMBLED THEREWITH

(75) Inventors: Norihiko Ito, Akita (JP); Kenzo Inoue, Akita (JP)

Correspondence Address: Studebaker & Brackett PC, 1890 Preston White Drive, Suite 105, Reston, VA, 20191, US

(73) Assignee: NAMIKI SEIMITSU HOUSEKI KABUSHIKI KAISHA, TOKYO (JP)

(21) Appl. No.: 12/097,351

(22) PCT Filed: Dec. 14, 2006
(86) PCT No.: PCT/JP2006/324895

§ 371 Date: Aug. 19, 2008

(30) Foreign Application Priority Data
Dec. 14, 2005 (JP) JP2005-360105

(51) Int. Cl. B26D 3/08; B25G 1/00; B25G 3/02

(52) U.S. Cl. 83/879; 16/110.1

(57) ABSTRACT

A shank of a diamond scriber suitable for substantially flat-surfaced materials that is to be scribed with particularly high loads. The shank includes a blind hole for retaining a diamond single crystal. The blind hole includes a rectangular mouth and four triangular sidewalls, each of which includes one edge of the rectangular mouth and meets the other three.

### BACKGROUND OF THE INVENTION

1. Field of the Invention

This invention relates to a shank for retaining a diamond single crystal and a diamond scriber assembled using the shank fitted with a diamond single crystal.

2. Description of the Related Art

It has long been well known that diamond single crystals have an extremely high wear resistance and distinctive semiconducting properties. Their wide range of practical applications include diamond scribers, diamond drills, grinding tools, electron beam sources (field emitters), contact-type roughness sensors, hardness test indenters, scratch test indenters, and AFM probes.

Of the practical above-mentioned applications, diamond scribers are widely used as tools for scribing the surfaces of substantially flat-surfaced materials such as single-crystal sapphire substrates or sheet glass to be divided. A diamond single crystal fitted on the tip of such a diamond scriber may be shaped in the form of, e.g., an approximately quadrangular pyramid having a flat top surface. Any of the intersection points of the ridges and the flat top surface of the approximately quadrangular pyramid is brought in contact with the surface of a substantially flat-surfaced material to be scribed on. A shank is used as a member for fixedly retaining the diamond single crystal.

According to a conventional method, a diamond single crystal and a metal shank can be joined by brazing to each other, with one end of the diamond single crystal inserted into a cylindrical hole coaxially drilled on one end of the metal shank, so that the {1 0 0} plane of the crystal will be perpendicular to the axis of the shank.

An example of the conventional method is shown in Japanese Examined Patent Publication No. 1972-20236, particularly in the “Detailed Description of the Invention,” in Paragraph 8 and FIG. 4 thereof.

Unfortunately, a shank according to Japanese Examined Patent Publication No. 1972-20236 has a drawback complicating the polishing process of the diamond single crystal. for example, the pre-polishing of the tip of the diamond single crystal retained by the polishing jig is required before fitting on the shank.

In a practical application such as a diamond scriber in which a diamond single crystal is fixedly fitted onto a shank of Japanese Examined Patent Publication No. 1972-20236, the diamond single crystal may move loosely before re-solidification of the brazing filler metal. Thus, the {1 0 0} plane of the diamond single crystal can easily lose its position perpendicular to the central axis of the shank. Consequently, there arises another drawback in that the crystal orientation of the diamond single crystal on the shank is difficult to optimize, thereby resulting in a failure to make full use of the excellent properties of the diamond single crystal.

In practical applications using a diamond single crystal, a diamond scriber in particular needs a high load in order to deeply scribe a thick and substantially flat-surfaced material to be divided, or in order to avoid slipping on a hard-to-scribe, chemically polished surface. When fitted on a shank of Japanese Examined Patent Publication No. 1972-20236, however, a diamond single crystal can easily get chipped without its wear resistance being fully exploited, thereby resulting in an yet another drawback of a shortened life of the diamond scriber.

### BRIEF SUMMARY OF THE INVENTION

The present invention was developed in order to overcome the drawbacks described above. The first purpose of the present invention is to provide a shank that allows full exploitation of the properties of a diamond single crystal. The second purpose of the present invention is to provide a diamond scriber suitable for substantially flat-surfaced materials that is to be scribed with a high loads.

The present invention was achieved based on the finding that a diamond single crystal can be optimally fitted on a shank by properly modifying the shape of the portion of the shank which is brought into contact with the diamond single crystal.

In other words, a first aspect of the present invention provides a shank characterized by a diamond single crystal-retaining blind hole that comprises a rectangular mouth, four triangular sidewalls, each including one edge of the rectangular mouth, and a vertex shared by the four triangular sidewalls.

It is generally known that, whether naturally produced or industrially synthesized by the high-pressure high-temperature (HPHT) method or the chemical vapor deposition (CVD) method, diamond single crystals can be in a regular octahedron shape either with a {1 1 1} plane as the principal plane or with {1 1 1} and {10 0} planes as the principal planes in the Miller index. Preferably, regular octahedron-shaped ones are to be used because the wide angles formed by their planes allow easy determination of their crystal orientations. Moreover, the four triangular sidewalls constituting the blind hole of the above-mentioned shank are formed so as to fit face-to-face on the four of the {1 1 1} planes of the diamond single crystal.

A second aspect of the present invention is a shank characterized by a diamond single crystal-retaining blind hole that comprises a rectangular mouth, two triangular and two approximately triangular sidewalls, each including one edge of the rectangular mouth, and a groove formed along a meeting line of opposite two of the four triangular sidewalls.

The diamond single crystal to be fitted on the shank can often have a shape slightly deviant from a regular octahedron because of the differences in growth rate between the respective {1 1 1} planes. With a groove formed on the bottom of the shank, the quadrangular pyramid-shaped blind hole is slightly deviant from an inverted single-vertexed quadrangular pyramid. The blind hole is formed into a shape slightly deviant from a quadrangular pyramid to ensure that its sidewalls will be securely joined to the four facets of the diamond single crystal having a shape slightly deviant from a regular octahedron.

A third aspect of the present invention is a shank, wherein the groove has a length of 1 percent or more and less than 10 percent of that of any edge of the diamond single crystal having an approximately regular octahedron shape.

If the groove has a length equal to or greater than 1 percent of that of an edge of the approximately regular octahedron shape, the geometric deviation of the diamond single crystal can be sufficiently corrected. On the other hand, if smaller than 10 percent, the approximately regular octahedron-shaped diamond single crystal can easily be stably supported. Thus, it is preferable that both of these conditions be satisfied.

A fourth aspect of the present invention is a shank, wherein the groove has a length of 1 percent or more and less than 10 percent of that of the edge shared by neighboring two of the triangular sidewalls.

If the groove has a length equal to or greater than 1 percent of that of the edge between the neighboring triangular sidewalls, any geometric deviation of the diamond single crystal can be effectively corrected. If smaller than 10 percent, the approximately regular octahedron-shaped diamond single crystal can be stably secured. Thus, it is preferable that both of these conditions be satisfied.

A fifth aspect of the present invention is a diamond scriber assembled using a shank in, wherein the shank is fitted with a diamond single crystal at its tip.

According to the present invention, the four facets of a regular octahedron-shaped diamond single crystal can be fitted face to face onto the four sidewalls that constitute the blind hole of a shank. Consequently, the diamond single crystal will be securely fixed on the shank. This reduces the possibility that the diamond single crystal may shift as fitted onto the shank. Accordingly, it becomes less likely that the plane on which the diamond single crystal demonstrates a strong wear resistance and semiconducting properties will deviate widely from the orientation intended in the design of a practical application such as a diamond scriber. Thus, there results an advantage that a shank can be provided which allows full exploitation of the properties of the diamond single crystal.

According to the present invention, a groove formed on the bottom of the blind hole in the shank allows for securely fitting the shank onto the regular octahedron-shaped diamond single crystal. Thus, there results another advantage that a shank can be provided that allows highly preferable fixation of a diamond crystal, naturally produced or industrially synthesized.

According to the present invention, the use of a shank that allows full exploitation of the wear resistance of a diamond single crystal results in yet another advantage that a diamond scriber can be provided which demonstrates an excellent anti-chipping property and a long cutting life even if used to cut thick and substantially flat-surfaced materials or ones having a chemically-polished surface.

### BRIEF DESCRIPTION OF THE DRAWINGS

In the attached drawings:

FIGS. 1(a) and 1(b) respectively show a top view and a cross-sectional view of a shank according to an embodiment of the present invention.

FIGS. 2(a) and 2(b) respectively show a top view and a cross-sectional view of a variant of a shank according to a preferred embodiment of the present invention.

FIG. 3 shows an enlarged view of the tip of a diamond single crystal according to an embodiment of the present invention.

FIGS. 4(a) and 4(b) respectively show a side view and a front view of a four-point diamond scriber according to an embodiment of the present invention.

FIGS. 5(a) to 5(e) are a series of cross-sectional views of an in-process four-point diamond scriber, which provide a step-by-step illustration of a method according to an embodiment of the present invention for fitting a diamond single crystal onto a shank.

FIGS. 6(a) and 6(b) respectively show an enlarged front view and an enlarged side view of a diamond single crystal fitted onto a diamond scriber according to an embodiment of the present invention.

### DETAILED DESCRIPTION OF THE INVENTION

Descriptions are provided below of the best mode for carrying out the present invention. This mode of embodiment relates to a shank 2 for retaining a diamond single crystal 3 having a distinctive shape.

The preferred material of a shank 2 in accordance with this mode of embodiment may be one such that demonstrates a high rigidity and an excellent adhesiveness to both the diamond single crystal 3 and a joining material 4. Specifically speaking, metals such as Fe, Ni, Zn, Cr, and Ti, or alloys thereof may be used as such. The shank 2 can be formed into shape by such a method as casting into molds the aforementioned material in the molten state and taking it out after cooling.

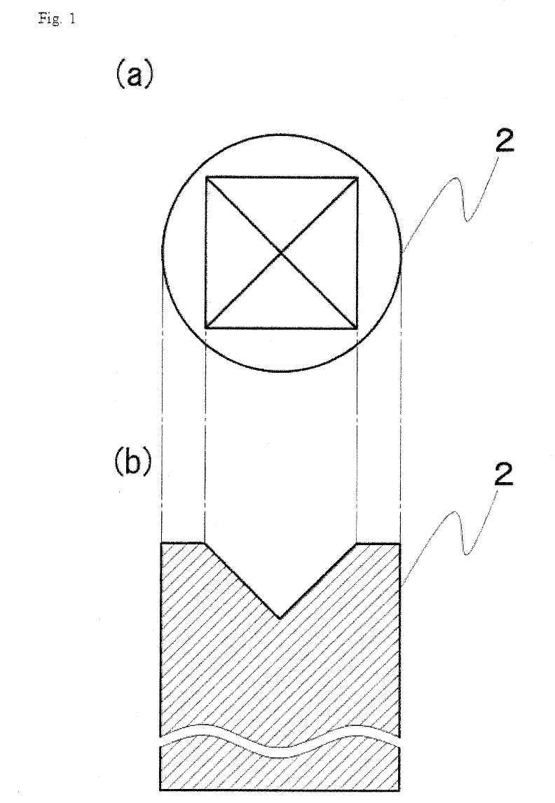

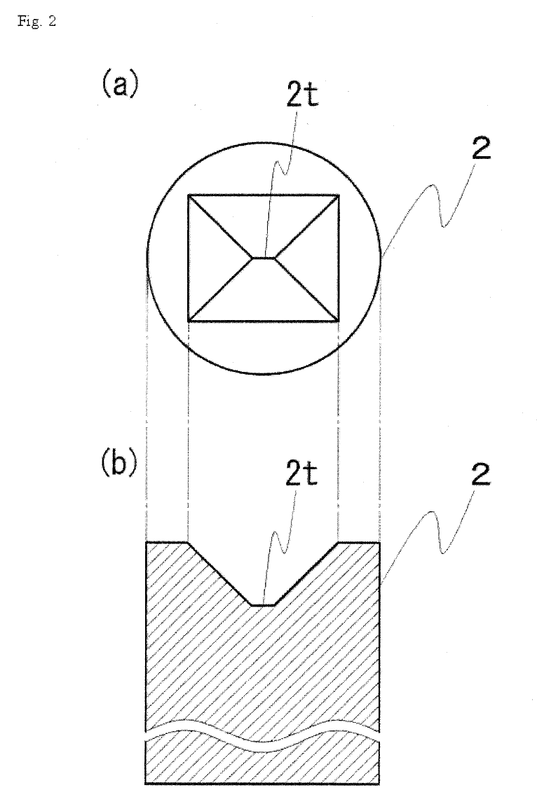

Then, the shank 2 has a blind hole in the portion for retaining the diamond single crystal 3. This blind hole comprises a rectangular mouth and four triangular sidewalls (including approximately triangular ones), each including one edge of the triangular mouth. While it is possible to configure the blind hole so that its four triangular sidewalls converge to share a single vertex as shown in FIG. 1, a more preferable configuration is to form a groove 2t in which opposite two of the four triangular sidewalls meet each other to share an edge, such as shown in FIG. 2.

Meanwhile, it is preferable that the diamond single crystal 3 retained by the shank 2 be an approximately regular octahedron-shaped one that has as the primary plane the {1 1 1} plane in the Miller index system. The diamond single crystal 3, produced naturally or synthesized industrially by the HPHT method or the CVD method, can often deviate from a geometrically ideal regular octahedron due to the differences in crystal growth rate between the respective directions equivalent to the <1 1 1> direction.

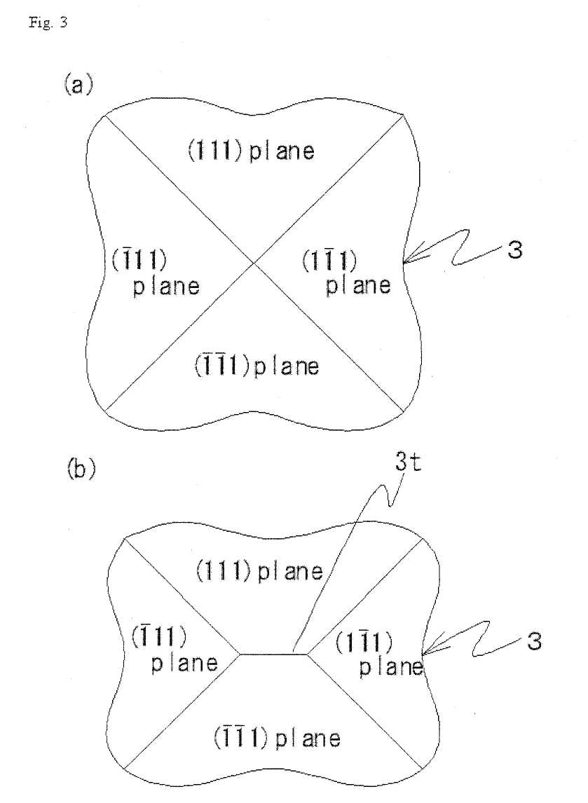

Specifically, if, in the diamond single crystal 3 as viewed from, the <1 0 0> direction, the diamond crystal growth rates in the <1 1 1> and <1 −1 −1> directions are equal to those in the <1 −1 1> and <1 1 −1> directions, respectively, the <1 0 0>-direction tip of the diamond single crystal 3 will grow to converge into a single vertex (FIG. 3(a)). On the other hand, however, if the diamond crystal growth rate in the <1 1 1> and <1 −1 −1> directions exceed those in the <1 −1 1> and <1 1 −1> directions, respectively, the <1 0 0>-direction tip of the diamond single crystal 3 will not grow to converge into a single vertex. Instead, the {1 −1 1} and {1 1 −1} planes will meet each other to share a linear top ridge 3t (FIG. 3(b)). The length of the top ridge 3t will often be shorter than 10 percent of that of any edge of the approximately regular octahedron-shaped diamond single crystal 3, though the length of the top ridge 3t may vary depending on the actual condition under which the diamond single crystal 3 grows.

Therefore, it is preferable that the blind hole of the shank 2 be configured so that opposite two of the aforementioned four sidewalls will meet each other to form and share the groove 2t. This is preferable because such a configuration will allow absorption of the geometric deviation of the diamond single crystal 3 into the shape of the shank 2 when the diamond single crystal 3 is fixedly fitted onto the shank 2 with the top ridge 3t engaged with the groove 2t.

Incidentally, the <1 −1 −1> direction mentioned above is the same as:
<1 1̅ 1̅>

which is a direction in the Miller index system.

It should be noted here that the outer shape of the shank 2 can be formed into various shapes, including but not limited to ones shown in FIGS. 1 and 2, as appropriate for use in practical applications.

Descriptions are provided below of a method of manufacturing a four-point scriber using a shank 2 in accordance with the above-described preferred embodiment of a practical application.

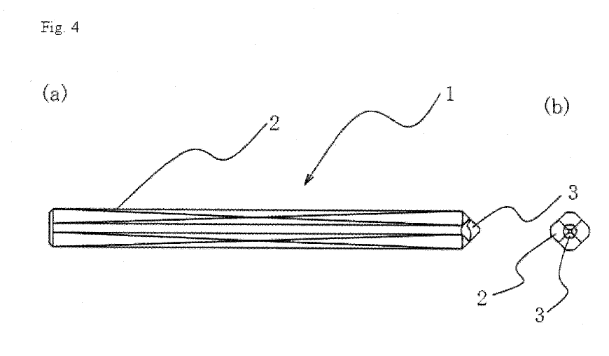

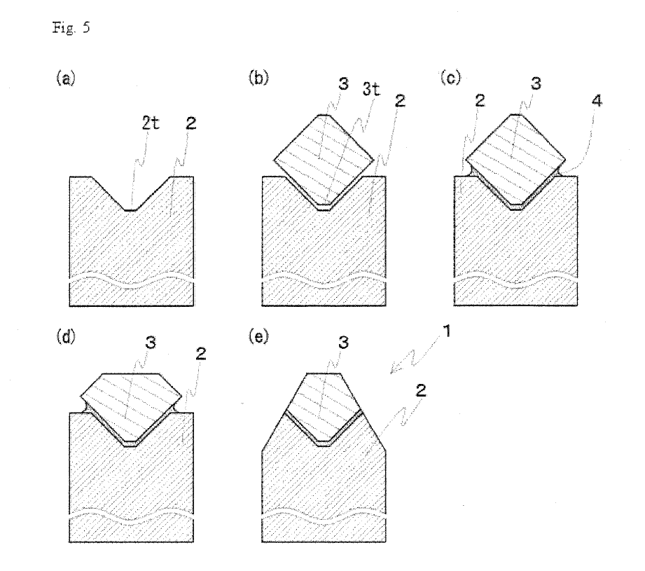

First, a shank 2 is prepared in accordance with the above-described embodiment. When a four-point scriber is manufactured, as an example of practical application, it is preferable that a bar-shaped shank 2 be used with its tip containing a blind hole as described above with respect to FIG. 5(a) and that the shank 2 be externally shaped like a quadrangular prism, as shown in FIGS. 4(a) and 4(b).

Then, following is a second step in which a diamond single crystal 3 is temporarily mated into the blind hole provided in the shank 2, as shown in FIG. 5(b). More specifically, the diamond single crystal 3 is temporarily fitted into the blind hole of the shank 2, with the four facets equivalent to the {1 1 1} plane of the diamond single crystal 3 being brought in face-to-face contact with the four sidewalls that constitute the blind hole of the shank 2, in order to determine the mounting orientation of the diamond single crystal 3.

When the shank 2 includes a groove 2t formed along the shared edge of opposite two of the four sidewalls that constitute the blind hole of the shank 2, it is preferable that the diamond single crystal 3 be fitted into the blind hole of the shank 2 with the top ridge 3t of the diamond single crystal 3 oriented in the same direction as that of the groove 2t of the shank 2. This fitting method is preferable because, with the diamond single crystal 3 thus fitted onto the shank 2, the diamond single crystal 3 can be prevented from tilting as fitted into the shank, whereby the central axis of the blind hole can be highly accurately aligned with the <1 0 0> direction of the diamond single crystal 3.

In a third step, with a joining material 4 placed between the diamond single crystal 3 and the shank 2, an appropriate pressure is applied evenly to the joining faces of the diamond single crystal 3 and the shank 2 to join the diamond single crystal 3 onto the shank 2 (FIG. 5(c)). Then, the joining material 4 is allowed to cool or dry until the diamond single crystal 3 is fixedly fitted onto the shank 2. A preferable joining material 4 may be, for example, epoxy adhesive or brazing filler metal, which becomes fluid at room temperature or under a heated condition.

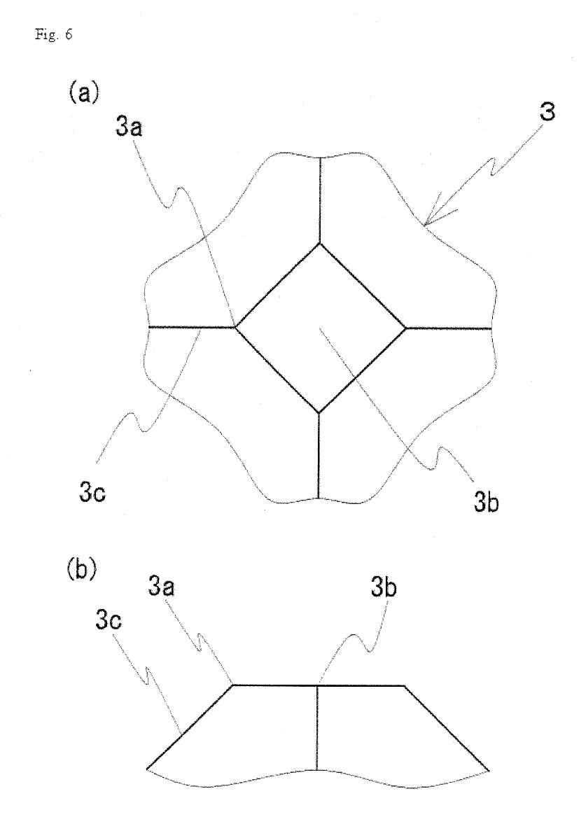

In a fourth step, as shown in FIG. 5(d), when the diamond single crystal 3 is fixedly fitted onto the specified part of the shank 2, the excess of the joining material 4 is removed as appropriate. Then, the diamond single crystal 3 is reshaped as appropriate for the intended application. For example, when a four-point scriber is the intended practical application, a tip surface 3b perpendicular to the axis of the shank 2 will be formed on the diamond single crystal 3 as shown in FIG. 6. Preferable methods of reshaping the diamond single crystal 3 may be any known reshaping technique such as grinding, laser beam machining, reactive ion etching (RIE), thermo-chemical processing, focused ion beam (FIB), and wet etching.

In an fifth step, finally, the facets reshaped according to the intended application are finished by polishing into high-precision and desirably directed crystal planes, thereby providing an excellent material for practical applications that allow full exploitation of the properties of the diamond single crystal 3. Examples of practical applications may include diamond scribers, diamond drills, grinding tools, electron beam sources (field emitters), contact-type roughness sensors, hardness tester indenters, scratch test indenters, or AFM probes, depending on the properties of the diamond single crystal 3. Thus, it is possible to manufacture the above-described example of four-point scriber 1, which has as a scribe point 3a the vertex formed by the tip surface 3b and ridge 3c, such as shown in FIG. 5(e). As the polishing technique of the diamond single crystal 3, any known polishing technique can be used such as scaife polishing.

The foregoing descriptions of a four-point scriber have been provided for explanatory purposes only to help illustrate an embodiment of an aspect of the present invention without limiting the scope thereof. It shall be understood that the applicability of the present invention extends to other preferred variants of diamond scriber 1 having various scribe points.

The present invention is explained in further details by the following variant. This variant is a four-point diamond scriber manufactured by fixedly fitting the top ridge of a diamond single crystal into the groove in the blind hole provided at the tip of a bar-shaped shank.

The diamond single crystal used in this variant is an approximately regular octahedron-shaped one with each edge 1.45 mm long (weight: approx. 0.005 g). Meanwhile, the shank used in this variant is provided at its tip with a 1 mm depth blind hole having a rectangular mouth 1.50 mm long and 1.45 mm wide. This blind hole has a 0.05 mm long groove formed on its bottom.

The diamond single crystal is fitted into the blind hole and fixed therein with a joining material in between and with the linear top ridge of the diamond single crystal engaged with the groove of the blind hole. Then, the diamond single crystal is provided at its tip with a tip surface perpendicular to the axis of the shank in order to finish the four-point diamond scriber.

Consequently, the central axis of blind hole deviated only by approximately 2 degrees from the <1 0 0> direction of the diamond single crystal. The four-point diamond scriber is thus finished with full advantage taken of the wear resistance of the diamond single crystal.

The following are descriptions of the numerical labels in the drawings:
1 Diamond scriber
2 Shank
2t Groove
3 Diamond single crystal
3a Scribe point
3b Tip surface
3c Ridge
3t Top ridge
4 Joining material.

1. A shank, comprising:
a blind hole for retaining a diamond single crystal, said blind hole comprising;
a rectangular mouth;
four triangular sidewalls, each including one edge of said rectangular mouth; and
a vertex shard by said four triangular sidewalls.

2. A shank comprising:
a blind hole for retaining a diamond single crystal, said blind hole comprising;
a rectangular mouth;
two triangular and two approximately triangular sidewalls, each including one edge of said rectangular mouth; and
a groove formed along a meeting line of opposite two of said four triangular sidewalls.

3. A shank according to claim 2, wherein said groove has a length of 1 percent or more and less than 10 percent of that of any edge of said diamond single crystal having an approximately regular octahedron shape.

4. A shank according to claim 2, wherein said groove has a length of 1 percent or more and less than 10 percent of that of an edge shared by neighboring two of said triangular sidewalls.

5. A diamond scriber assembled using a shank as claimed in claim 1, wherein said shank is fitted with a diamond single crystal at its tip.

6. A diamond scriber assembled using a shank as claimed in claim 2, wherein said shank is fitted with a diamond single crystal at its tip.

7. A diamond scriber assembled using a shank as claimed in claim 3, wherein said shank is fitted with a diamond single crystal at its tip.

8. A diamond scriber assembled using a shank as claimed in claim 4, wherein said shank is fitted with a diamond single crystal at its tip.
